(19) United States
(12) Patent Application Publication
(10) Pub. No.: US 2015/0029136 A1
(43) Pub. Date: Jan. 29, 2015

(54) SUPERHETERODYNE PEN STIMULUS SIGNAL RECEIVER

(71) Applicant: Apple Inc., Cupertino, CA (US)

(72) Inventor: Shahrooz SHAHPARNIA, Campbell, CA (US)

(73) Assignee: Apple Inc., Cupertino, CA (US)

(21) Appl. No.: 14/067,901

(22) Filed: Oct. 30, 2013

Related U.S. Application Data
(60) Provisional application No. 61/859,726, filed on Jul. 29, 2013.

(51) Int. Cl. G06F 3/044; G06F 3/0354; G06F 3/038; G06F 3/041

(52) U.S. Cl. CPC G06F 3/044; G06F 3/0416; G06F 3/03545; G06F 3/038
USPC 345/174

(57) ABSTRACT

A superheterodyne stylus signal receiver for detecting a stylus stimulation signal from a stylus is provided. The stylus signal receiver can be configured to convert the touch signal into an intermediate frequency signal having a frequency that is less than that of the touch signal. In some examples, a hardware-implemented I-phase demodulator can be used to convert the touch signal into the intermediate frequency signal. The receiver can be further configured to perform IQ demodulation on the intermediate frequency signal at the intermediate frequency signal's lower frequency. In some examples, the IQ demodulation can be performed in firmware.

### FIELD

This relates generally to touch sensitive devices and, more specifically, to touch sensitive devices that can also accept input from a stylus.

### BACKGROUND

Touch sensitive devices have become popular as input devices to computing systems due to their ease and versatility of operation as well as their declining price. A touch sensitive device can include a touch sensor panel, which can be a clear panel with a touch sensitive surface, and a display device, such as a liquid crystal display (LCD), that can be positioned partially or fully behind the panel or integrated with the panel so that the touch sensitive surface can cover at least a portion of the viewable area of the display device. The touch sensitive device can allow a user to perform various functions by touching the touch sensor panel using a finger, stylus, or other object at a location often dictated by a user interface (IA) being displayed by the display device. In general, the touch sensitive device can recognize a touch event and the position of the touch event on the touch sensor panel, and the computing system can then interpret the touch event in accordance with the display appearing at the time of the touch event, and thereafter can perform one or more actions based on the touch event.

As touch sensing technology continues to improve, touch sensitive devices are increasingly being used to compose and mark-up electronic documents. In particular, styluses have become popular input devices as they emulate the feel of traditional writing instruments. Most conventional styluses simply include a bulky tip made of a material capable of interacting with the touch sensitive device in a manner resembling a user's finger. As a result, conventional styluses lack the precision and control of traditional writing instruments. A stylus capable of generating stylus stimulation signals that can be transmitted to the touch sensitive device can improve the precision and control of the stylus. However, a touch sensitive device capable of detecting such a stimulation signal may require additional hardware and consume more power than a conventional touch sensitive device.

### SUMMARY

A superheterodyne stylus signal receiver for detecting a stylus stimulation signal from a stylus is provided. The stylus signal receiver can be configured to convert the touch signal into an intermediate frequency signal having a frequency that is less than that of the touch signal. In some examples, a hardware-implemented I-phase demodulator can be used to convert the touch signal into the intermediate frequency signal. The receiver can be further configured to perform IQ demodulation on the intermediate frequency signal at the intermediate frequency signal's lower frequency. In some examples, the IQ demodulation can be performed in firmware.

### BRIEF DESCRIPTION OF THE DRAWINGS

FIG. 1 illustrates an exemplary touch sensor that can be used with a touch sensitive device according to various examples.

FIG. 2 illustrates a block diagram of an exemplary stylus according to various examples.

FIG. 3 illustrates a block diagram of an exemplary control system for a touch sensor that can detect both a user's touch and signals from a stylus according to various examples.

FIG. 4 illustrates a block diagram of an exemplary control system showing the interaction between a stylus and a touch sensor according to various examples.

FIG. 5 illustrates a functional block diagram of a superheterodyne signal receiver according to various examples.

FIG. 6 illustrates an exemplary process for demodulating a touch signal from a touch sensor according to various examples.

FIG. 7 illustrates an exemplary system for demodulating a touch signal according to various examples.

FIGS. 8-11 illustrate exemplary personal devices that include a superheterodyne signal receiver for detecting signals from a stylus according to various examples.

### DETAILED DESCRIPTION

In the following description of examples, reference is made to the accompanying drawings in which it is shown by way of illustration specific examples that can be practiced. It is to be understood that other examples can be used and structural changes can be made without departing from the scope of the various examples.

This relates to detecting a stylus stimulation signal from a stylus using a superheterodyne stylus signal receiver. The stylus signal receiver can be configured to convert the touch signal into an intermediate frequency signal having a frequency that is less than that of the touch signal. In some examples, a hardware-implemented I-phase demodulator can be used to convert the touch signal into the intermediate frequency signal. The receiver can be further configured to perform IQ demodulation on the intermediate frequency signal at the intermediate frequency signal's lower frequency. In some examples, the IQ demodulation can be performed in firmware, advantageously reducing the amount of hardware required to perform IQ demodulation of the touch signal. As a result, the cost, space, and power required by the stylus signal receiver are reduced.

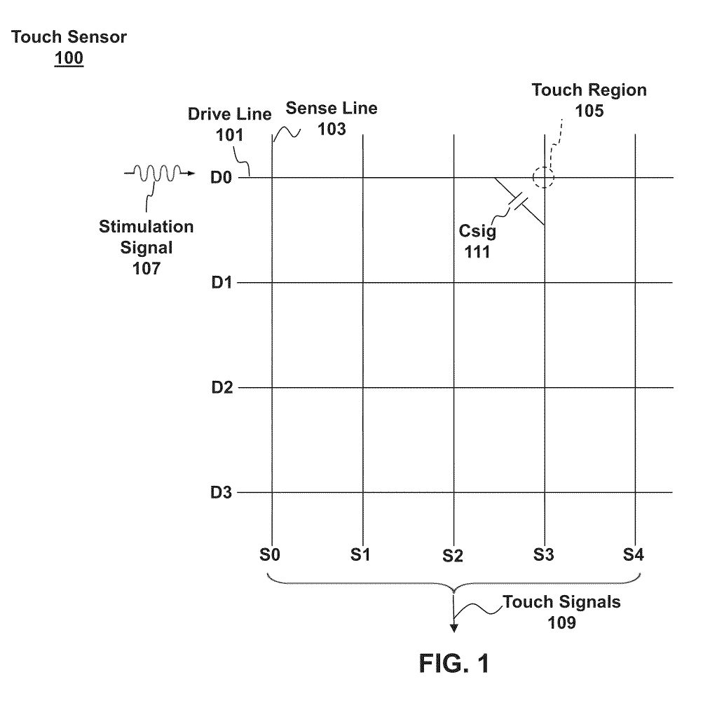

FIG. 1 illustrates touch sensor 100 that can be used to detect touch events on a touch sensitive device, such as a mobile phone, tablet, touchpad, portable or desktop computer, portable media player, or the like. Touch sensor 100 can include an array of touch regions or nodes 105 that can be formed at the crossing points between rows of drive lines 101 (D0-D3) and columns of sense lines 103 (S0-S4), although it should be understood that the row/drive line and column/sense line associations are only exemplary. Each touch region 105 can have an associated mutual capacitance Csig 111 formed between the crossing drive lines 101 and sense lines 103 when the drive lines are stimulated. The drive lines 101 can be stimulated by stimulation signals 107 provided by drive circuitry (not shown) and can include an alternating current (AC) waveform. The sense lines 103 can transmit touch signals 109 indicative of a touch at the touch sensor 100 to sense circuitry (not shown), which can include a sense amplifier for each sense line, or a fewer number of sense amplifiers that can be multiplexed to connect to a larger number of sense lines.

To sense a touch at the touch sensor 100, drive lines 101 can be stimulated by the stimulation signals 107 to capacitively couple with the crossing sense lines 103, thereby forming a capacitive path for coupling charge from the drive lines 101 to the sense lines 103. The crossing sense lines 103 can output touch signals 109, representing the coupled charge or current. When an object, such as a passive stylus, finger, etc., touches the touch sensor 100, the object can cause the capacitance Csig 111 to reduce by an amount ΔCsig at the touch location. This capacitance change ΔCsig can be caused by charge or current from the stimulated drive line 101 being shunted through the touching object to ground rather than being coupled to the crossing sense line 103 at the touch location. The touch signals 109 representative of the capacitance change ΔCsig can be received by the sense lines 103 and transmitted to the sense circuitry for processing. The touch signals 109 can indicate the touch region where the touch occurred and the amount of touch that occurred at that touch region location.

While the example shown in FIG. 1 includes four drive lines 101 and five sense lines 103, it should be appreciated that touch sensor 100 can include any number of drive lines 101 and any number of sense lines 103 to form the desired number and pattern of touch regions 105. Additionally, while the drive lines 101 and sense lines 103 are shown in FIG. 1 in a crossing configuration, it should be appreciated that other configurations are also possible to form the desired touch region pattern. While FIG. 1 illustrates mutual capacitance touch sensing, other touch sensing technologies may also be used in conjunction with examples of the disclosure, such as self-capacitance touch sensing, resistive touch sensing, projection scan touch sensing, and the like. Furthermore, while various examples describe a sensed touch, it should be appreciated that the touch sensor 100 can also sense a hovering object and generate hover signals therefrom.

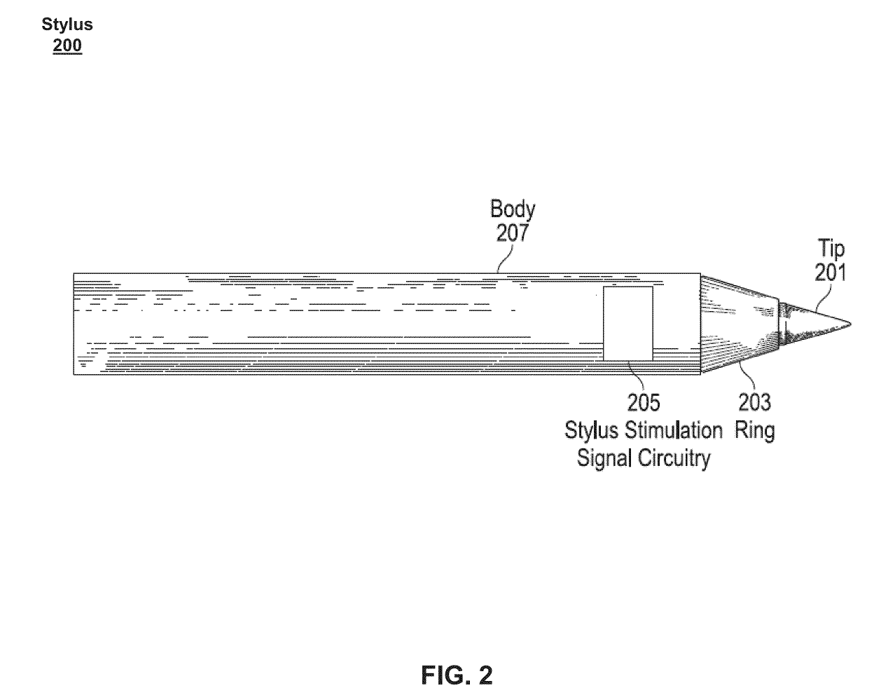

FIG. 2 illustrates a block diagram of an exemplary stylus 200 that can be used with a touch sensitive device, such as a mobile phone, touchpad, portable or desktop computer, or the like. Stylus 200 can generally include tip 201, ring 203, body 207, and stylus stimulation signal circuitry 205 located within body 207. As will be described in greater detail below, stylus stimulation signal circuitry 205 can be used to generate a stylus stimulation signal that can be transmitted to a touch sensitive device through tip 201. The stylus stimulation signal generated by stylus stimulation signal circuitry 205 can be similar to that generated by the drive circuitry of the touch sensitive device and can cause a charge to be built up on drive lines 101 and sense lines 103 due to capacitive coupling with stylus tip 201. However, the frequency of the stylus stimulation signal generated by stylus stimulation signal circuitry 205 can be different than and orthogonal to the frequency of stimulation signal 107 generated by the drive circuitry of the touch sensitive device. In this way, the sense circuitry of the touch sensitive device can distinguish between touch signals 109 caused by the stylus stimulation signal and the touch signals 109 caused by stimulation signals 107 generated by the drive circuitry of the touch sensitive device.

Tip 201 of stylus 200 can include a material capable of transmitting the stylus stimulation signal from stylus stimulation signal circuitry 205 to the touch sensitive device, such as a flexible conductor, a metal, a conductor wrapped by a non-conductor, a non-conductor coated with a metal, a transparent conducting material (e.g., indium tin oxide (ITO)) or a transparent non-conductive material (e.g., glass or plastic) coated with a transparent (e.g., ITO) (if the tip is also used for projection purposes) or opaque material, or the like. In some examples, tip 201 can have a diameter of about 1.5 mm or less. Tip 201, which can be used to transmit stimulus signals from the stylus, can be implemented using a conductive ring 203. Ring 203 can include a conductive material, such as a flexible conductor, a metal, a conductor wrapped by a non-conductor, a non-conductor coated with a metal, a transparent conducting material (e.g., ITO), a transparent non-conductive material (e.g., glass) coated with a transparent material (e.g., ITO if the tip is used for projection purposes) or opaque material, or the like. Ring 203 can serve other purposes, such as providing an alternative means for transmitting the stylus stimulation signal from the stylus to the touch sensitive device. Similarly, tip 201 or ring 203 can also be used to sense the drive signal from the touch sensitive device. Both tip 201 and ring 203 can be segmented and each segment can be independently controlled according to the description above.

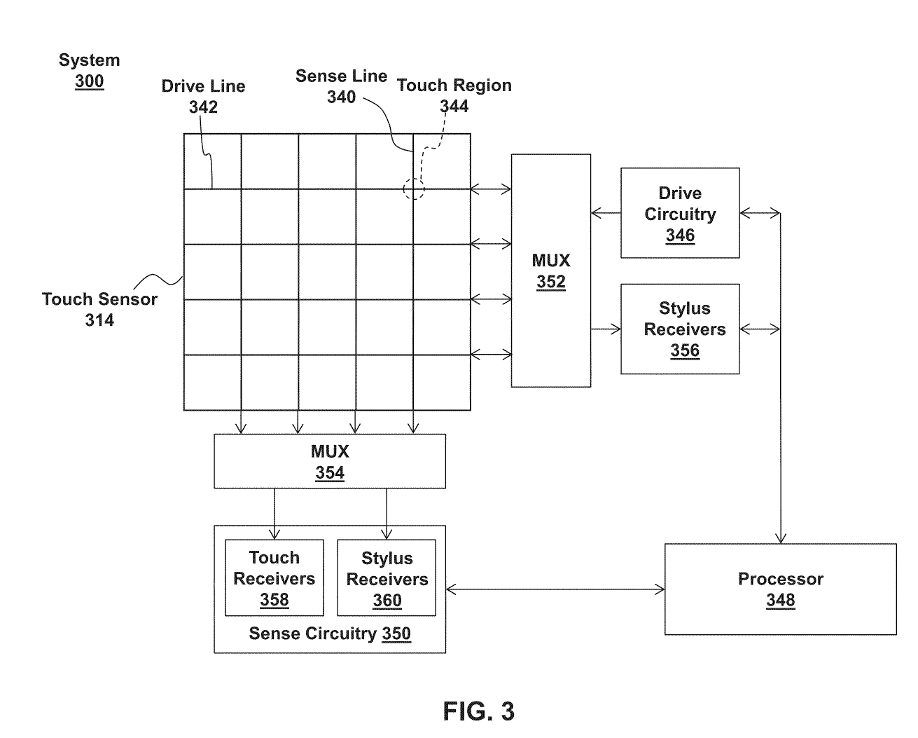

FIG. 3 illustrates a block diagram of an exemplary control system 300 for a touch sensor that can detect both a user's touch and signals from a stylus according to various examples. System 300 can be included within a touch sensitive device, such as a mobile phone, tablet, touchpad, portable or desktop computer, portable media player, or the like.

System 300 can include a touch sensor 314 similar or identical to touch sensor 100 that can be configured to detect touch (or hover) events on the surface of a touch screen of the touch sensitive device, as described above with reference to FIG. 1. Touch sensor 314 can include sensing regions 344 formed by one or more electrodes (explained below) that can act as a first electrically conductive member and an object, such as a finger of the user, that forms a second electrically conductive member. Touch sensor 314 can be configured in a self-capacitance arrangement or in a mutual capacitance arrangement.

In a self-capacitance arrangement, touch sensor 314 can include a single layer of multiple electrodes that are spaced in a grid or other arrangement where each electrode may form a region 344. Sense circuitry 350 can be configured to monitor changes in capacitance that can occur at each region 344. These changes typically occur at a node 344 when an object (e.g., finger) is placed in close proximity to the electrode.

In a mutual capacitance arrangement, touch sensor 314 can include two layers of electrodes that form drive lines 342 and sense lines 340. Specifically, drive lines 342 can be formed on a first layer and sense lines 340 can be formed on a second layer. Regions 344 can be formed at locations where drive lines 342 cross over or under sense lines 340 (although they are typically placed in different layers). Sense lines 340 can intersect drive lines 342 in a variety of ways. For instance, in one example, sense lines 340 can be perpendicular to the drive lines 342, thus forming an arrangement of regions 344 that are horizontally and vertically aligned, as shown in FIG. 3. In other examples, other configurations of sense lines 340 and drive lines 342 can be used.

System 300 can further include drive circuitry 346 coupled to each of the drive lines 342. The drive circuitry 346 can be configured to provide a stimulation signal (e.g., voltage) similar or identical to stimulation signal 107 to the drive lines 342. Sense circuitry 350 can be coupled to each of the sense lines 340 and can be configured to detect changes in capacitance at the regions 344 in the same manner as described with respect to FIG. 1. In operation, drive circuitry 346 can apply stimulation signals to drive lines 342, which, due to the capacitive coupling between drive lines 342 and sense lines 340 at each region 344, can cause a charge to be generated in sense lines 340. The charge generated in sense lines 340 can be received by sense circuitry 350 as touch signals. Sense circuitry 350 can use the touch signals to monitor changes in capacitance at each of the regions 344.

System 300 can be configured to operate in a first touch detection mode and a second stylus detection mode. In the first touch detection mode, drive circuitry 346 can provide stimulation signals to drive lines 342 and sense circuitry 350 can scan sense lines 340 to detect changes in capacitance at regions 344 caused by an object, such as a finger, at or near regions 344. In the second stylus detection mode, drive circuitry can cease to generate stimulation signals and both the drive lines 342 and sense lines 342 can be scanned to detect touch signals caused by charge capacitively coupled into the drive lines 342 and sense lines 340 by the stylus stimulation signal from stylus 200.

In some examples, system 300 can include multiplexers 352 and 354 for switching between the first touch detection mode and the second stylus detection mode. For example, multiplexer 352 can be configured to couple drive circuitry 346 to provide stimulation signals to drive lines 342 during the first touch detection mode and to couple stylus receivers 356 to scan drive lines 342 for touch signals caused by a stylus stimulation signal during the second stylus detection mode. Similarly, multiplexer 354 can be configured to couple touch receivers 358, which can be configured to demodulate touch signals caused by a stimulation signal generated by drive circuitry 346, to scan sense lines 340 during the first touch detection mode and to couple stylus receivers 360, which can be configured to demodulate touch signals caused by a stylus stimulation signal generated by stylus 200, to scan sense lines 340 during the second stylus detection mode. Since stylus receivers 356 may be used to only detect touch signals caused by a stylus stimulation signal, stylus receivers 356 can include stylus receivers similar or identical to stylus receivers 360.

In other examples, sense circuitry 350 can be used to scan both sense lines 340 and drive lines 342. In these examples, stylus receivers 356 can be omitted and system 300 can include another multiplexer to selectively couple sense circuitry 350 to drive lines 342 and sense lines 340 during the second stylus detection mode.

In some examples, system 300 can be configured to switch between the first and second modes of operation. For example, system 300 can operate in the first touch detection mode of operation for a first length of time (e.g., 6 ms) and then switch to the second stylus detection mode of operation for a second length of time (e.g., 2 ms). System 300 can be configured to continually switch between the first and second modes of operation. However, in other examples, other durations can be used and the durations need not remain constant throughout the switching. For example, when a touch signal is detected during the second stylus detection mode, the second duration of time can be increased to provide more stylus detection. Similarly, if no touch signal is detected during the second stylus detection mode, the second duration of time can be decreased.

In either the self-capacitance or mutual capacitance arrangements discussed above, sensing circuitry 350 and stylus receivers 356 can be used to detect changes in capacitance at each touch region 344. This can allow sensing circuitry 350 and stylus receivers 356 to determine when and where an object or active stylus has touched or hovered near touch sensor 314. Sense circuitry 350 and stylus receivers 356 can be coupled to communicate touch sensing data to processor 348. In some examples, sense circuitry 350 and stylus receivers 356 can be configured to convert the analog touch signals received from touch sensor 314 to digital data and transmit the digital data to processor 348. Sense circuitry 350 and stylus receivers 356 can include individual receivers for each drive or sense line 340, 342 or can include one or more receivers that can be shared between the drive and sense lines 340, 342.

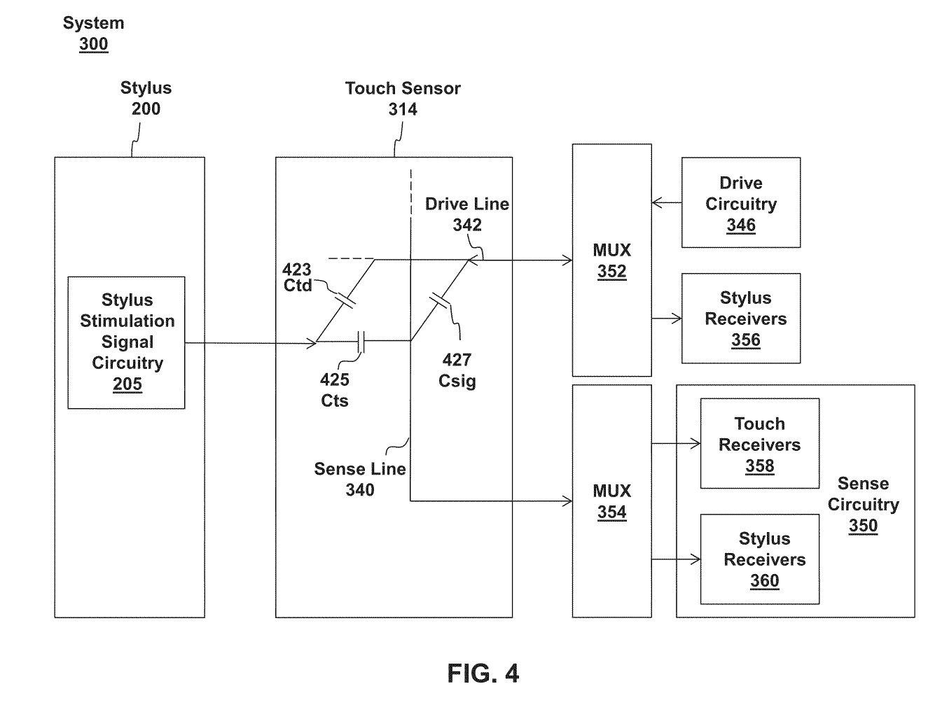

FIG. 4 illustrates a block diagram of control system 300 showing the interaction between stylus 200 and touch sensor 314. It should be appreciated that touch sensor 314 is shown with only one drive line and one sense line for illustrative purposes only and that touch sensor 314 can actually include any number of drive lines and any number of sense lines.

A mutual capacitance Csig 427 can be formed between the crossing drive line 342 and sense line 340 when the drive line is stimulated. Similarly, a mutual capacitance Cts 425 and Ctd 423 can be formed between the tip of stylus 200 and sense line 340 and drive line 342, respectively, when the stylus stimulation signal is generated. As mentioned above, if the tip of stylus 200 is placed near or at the crossing point between drive line 342 and sense line 340, stylus 200 can transmit a stylus stimulation signal into drive lines 342 and sense lines 340 of touch sensor 314 via the capacitive paths formed between the stylus tip and the drive and sense lines 342, 340. Thus, the stylus stimulation signal from stylus 200 can cause touch signals to be generated in both drive lines 342 and sense lines 340.

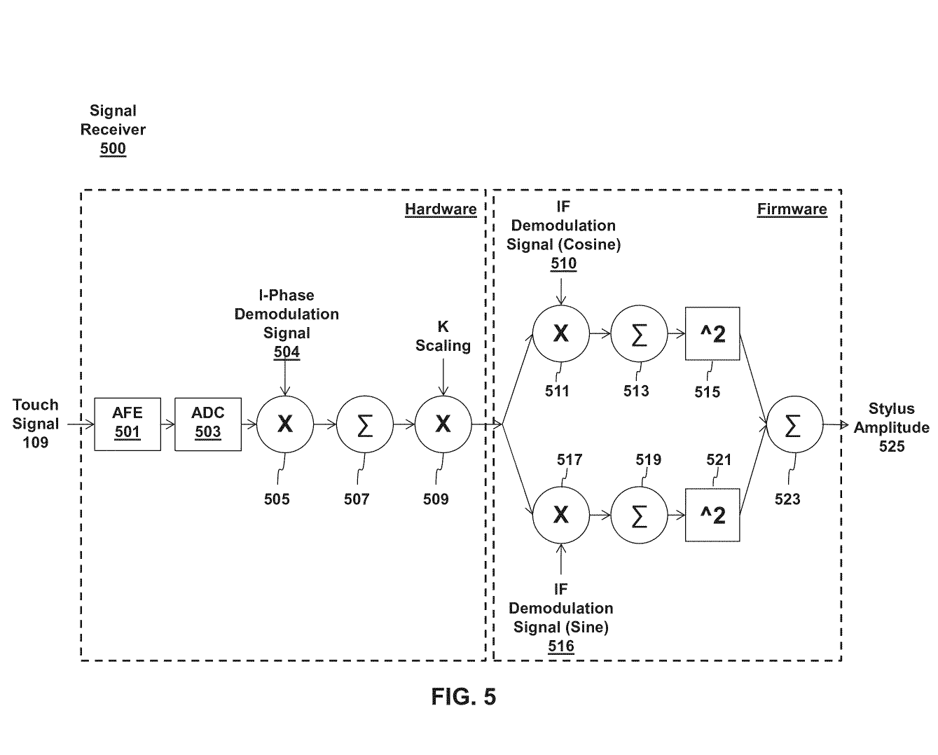

FIG. 5 illustrates a functional block diagram of an exemplary superheterodyne signal receiver 500 for demodulating a touch signal generated in response to a stylus stimulation signal. Signal receiver 500 can be configured to down-convert a touch signal 109 to an intermediate frequency and perform IQ demodulation at the intermediate frequency. In some examples, the IQ demodulation can be performed in firmware, obviating the need for hardware-implemented IQ demodulators. Signal receiver 500 can be included within stylus receivers 360 or stylus receivers 356 in system 300. As discussed above, individual sense receivers 500 can be used for each sense/drive line 340, 342 or one or more sense receivers 500 can be used for multiple sense/drive lines 340, 342.

Sense receiver 500 can include analog front end (AFE) circuitry 501 coupled to receive a touch signal 109 from sense line 340 or drive line 342 of touch sensor 314. AFE circuitry 501 can include any type of analog circuitry to provide any analog signal processing needs, such as amplification, filtering, attenuation, etc., for touch signal 109 prior to being sent to analog to digital converter (ADC) 503. ADC 503 can be configured to convert the analog touch signal 109 into a digital touch signal. Sense receiver 500 can further include I-phase demodulation mixer 505 coupled to receive the digital touch signal from ADC 503 and an I-phase demodulation signal 504. I-phase demodulation signal 504 can include a sinusoidal signal having a frequency such that the mixing of I-phase demodulation signal 504 with the digital touch signal from ADC 503 generates an intermediate frequency signal having an intermediate frequency that is lower than the frequency of the digital touch signal. For example, if the stylus stimulation signal has a frequency of 110 KHz, a touch signal 109 generated in response to the stylus stimulation signal may also have a frequency of 110 KHz. In this example, I-phase demodulation signal 504 can be selected to have a frequency that is 500 Hz greater or less than 110 KHz. As a result, the frequency of the intermediate frequency signal output by I-phase demodulation mixer 505 can be 500 Hz. While specific values have been provided, it should be appreciated that other values may be selected to generate an intermediate frequency signal having an intermediate frequency that is less than the frequency of touch signal 109.

Sense receiver 500 can further include integrator 507 for averaging the intermediate frequency signal output by I-phase demodulation mixer 505. Integrator 507 can be configured to integrate the intermediate frequency signal from I-phase demodulation mixer 505 over a duration of time selected to be less than half of the period of the intermediate frequency signal. This can be performed to sample the mixed signal at a frequency greater than or equal to the Nyquist sampling rate for the intermediate frequency signal. Continuing with the example provided above, if the intermediate frequency signal output by I-phase demodulation mixer 505 has a frequency of 500 Hz, integrator 507 can be configured to integrate the mixed signal every 100 μs. This sampling rate of 10 kHz results in 20 samples per period of the mixed signal. While a specific integration duration has been provided, it should be appreciated that other values may be selected to sample the mixed signal at a frequency greater than or equal to the Nyquist sampling rate. Additionally, other low-pass filters can be used in place of integrator 507.

Sense receiver 500 can further include scaling mixer 509 coupled to receive the sampled intermediate frequency signal from integrator 507. Scaling mixer 509 can be further coupled to receive a scaling factor K to amplify the sampled intermediate frequency signal. In one example, the scaling factor K can have a value of 2. However, it should be appreciated that other values can be used as appropriate for a particular circuit implantation.

Sense receiver 500 can further include I-phase demodulation mixer 511 coupled to receive the scaled output of scaling mixer 509. I-phase demodulation mixer 511 can be further coupled to receive an intermediate frequency demodulation signal 510 having the same frequency as the scaled output of scaling mixer 509 (e.g., 500 Hz). Sense receiver 500 can further include integrator 513 coupled to receive and integrate the output of I-phase demodulation mixer 511. The integrated output of integrator 513 can be squared, or multiplied by itself, at block 515.

Sense receiver 500 can further include Q-phase demodulation mixer 517 coupled to receive the scaled output of scaling mixer 509. Q-phase demodulation mixer 517 can be further coupled to receive an intermediate frequency demodulation signal 516. Intermediate frequency demodulation signal 516 can be similar to intermediate frequency demodulation signal 510, except that it can be 90-degrees out of phase from intermediate frequency demodulation signal 510. For example, intermediate frequency demodulation signal 510 can be a cosine signal while intermediate frequency demodulation signal 516 can be a sine signal having the same frequency and phase values. Sense receiver 500 can further include integrator 519 coupled to receive and integrate the output of Q-phase demodulation mixer 517. The integrated output of integrator 519 can be squared, or multiplied by itself, at block 521.

Sense receiver can further include integrator 523 coupled to receive and add together the squared outputs of blocks 515 and 521. The square-root of the output of integrator 523 can represent the amplitude 525 of the sensed touch signal 109 caused by the stylus stimulation signal. The amplitude 525 detected for the particular drive or sense line can be provided to processor 348 where it can be processed along with detected amplitudes for the other drive and sense lines to determine a position of stylus 200 on touch sensor 314. For example, the intersection of the sense line and drive line experiencing the largest touch signal amplitude can be determined to be the location of stylus 200.

In some examples, by down-converting the frequency of touch signal 109 produced by the stylus stimulation signal, the down-converting circuitry (e.g., components 501, 503, 505, 507, and 509) can be implemented in hardware, while the functions represented by components 511, 513, 515, 517, 519, 521, and 523 can be implemented in firmware (e.g., performed by a processor of the touch sensitive device). This advantageously reduces the hardware required to perform IQ demodulation of the touch signal produced by the stylus stimulation signal since only one I-phase demodulator 505 can be implemented in hardware. As a result, the cost, space, and power required by the stylus signal receiver are reduced.

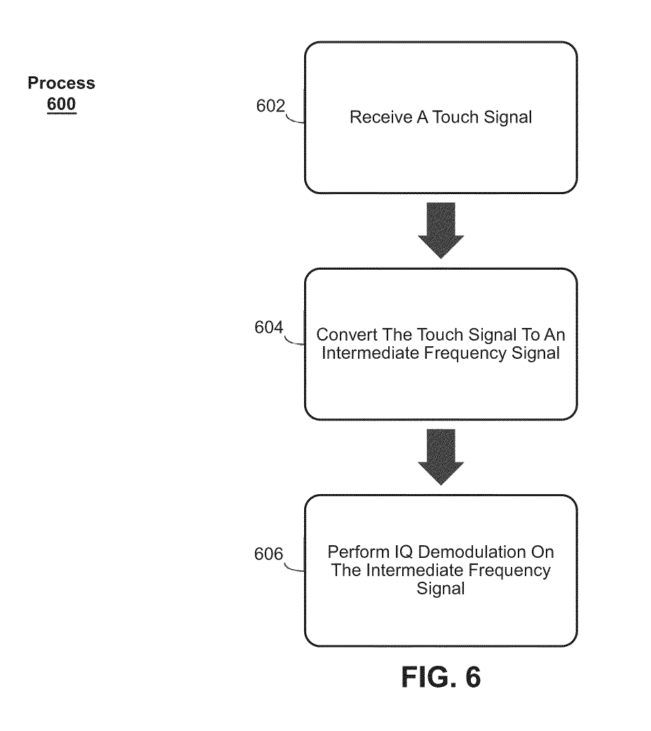

FIG. 6 illustrates an exemplary process 600 for demodulating a touch signal generated in response to a stylus stimulation signal. At block 602, a touch signal can be received. The touch signal can be similar or identical to touch signal 109 received from a drive line or a sense line from a touch sensor similar or identical to touch sensor 100 or 314. However, the touch signal can be generated in response to the touch sensor receiving a stylus stimulation signal from a stylus similar or identical to stylus 200 rather than in response to a stimulation signal from the touch sensor's drive circuitry. In one example, the touch signal can be received by a signal receiver similar or identical to signal receiver 500. In some examples, the touch signal can be processed using AFE circuitry similar or identical to AFE circuitry 501 to provide amplification, filtering, attenuation, etc. Additionally, the analog touch signal can be converted into a digital signal using ADC circuitry similar or identical to ADC 503.

At block 604, the touch signal received at block 602 can be converted to a signal having an intermediate frequency that is lower than the frequency of the touch signal. This can include mixing the touch signal with a demodulation signal having a different frequency to produce a signal having an intermediate frequency equal to the difference between the touch signal frequency and the demodulation signal frequency. For example, the touch signal can be mixed with a demodulation signal similar or identical to I-phase demodulation signal 504 using a demodulation mixer similar or identical to I-phase demodulation mixer 505. In one example, if the touch signal 109 has a frequency of 110 KHz, the I-phase demodulation signal may be selected to have a frequency that is 500 Hz greater or less than 110 KHz.

In some examples, the intermediate frequency signal can then be integrated over a duration of time selected to be less than half of the period of the intermediate frequency signal. This can be performed to sample the intermediate frequency signal at a frequency greater than or equal to the Nyquist sampling rate. For instance, continuing with the example provided above, if the intermediate frequency signal has a frequency of 500 Hz, an integrator similar or identical to integrator 507 can be used to integrate the intermediate frequency signal every 100 μs. This sampling rate of 10 kHz results in 20 samples per period of the intermediate frequency signal. While a specific integration duration has been provided, it should be appreciated that other values may be selected to sample the intermediate frequency signal at a frequency greater than or equal to the Nyquist sampling rate. Additionally, other low-pass filters techniques can be used instead of integration.

In some examples, the sampled intermediate frequency signal can be scaled by a factor K using a mixer similar or identical to scaling mixer 509. In one example, the scaling factor K can have a value of 2. However, it should be appreciated that other values can be used as appropriate for a particular circuit implantation.

At block 606, IQ demodulation can be performed on the intermediate frequency signal. This can include performing I-phase demodulation and Q-phase demodulation on the sampled and scaled intermediate frequency signal generated at block 604 at the intermediate frequency. The results of the I-phase and Q-phase demodulations can be squared, added, and the square-root of the sum taken as an amplitude of the touch signal generated by the stylus stimulation signal.

For example, the sampled and scaled intermediate frequency signal can be mixed with an intermediate frequency demodulation signal having the same frequency as the sampled and scaled intermediate frequency signal using a mixer similar or identical to I-phase demodulation mixer 511. This intermediate frequency demodulation signal can be similar or identical to intermediate frequency demodulation signal 510. The demodulated signal can then be integrated using an integrator similar or identical to integrator 513 and squared using an operation similar to that of block 515.

The IQ demodulation performed at block 606 can further include performing Q-phase demodulation on the sampled and scaled intermediate frequency signal generated at block 604 at the intermediate frequency. For example, the sampled and scaled intermediate frequency signal can be mixed with an intermediate frequency demodulation signal having the same frequency as the sampled and scaled intermediate frequency signal using a mixer similar or identical to Q-phase demodulation mixer 517. This IF demodulation signal can be 90 degrees out of phase from the intermediate frequency demodulation signal used for the I-phase demodulation and can be similar or identical to intermediate frequency demodulation signal 516. The demodulated signal can then be integrated using an integrator similar or identical to integrator 519 and squared using an operation similar to that of block 521.

The squared results of the I-phase and Q-phase demodulations can be added together using an integrator similar or identical to integrator 523. The square-root of the sum can be calculated and can represent the amplitude of the touch signal received at block 602 that was caused by the stylus stimulation signal.

In some examples, blocks 602 and 604 can be performed in hardware of the signal receiver, while block 606 can be performed using firmware as discussed above with respect to FIG. 5.

Process 600 can be repeated any number of times to demodulate touch signals from any number of drive or sense lines. The outputs from process 600 can be further processed to determine a location of a stylus similar or identical to stylus 200 on a touch sensor. For example, the amplitudes determined using process 600 can be used to identify a drive line and sense line having the strongest detected touch signal. As a result, a location of the stylus can be determined to be the intersection of the detected drive line and sense line.

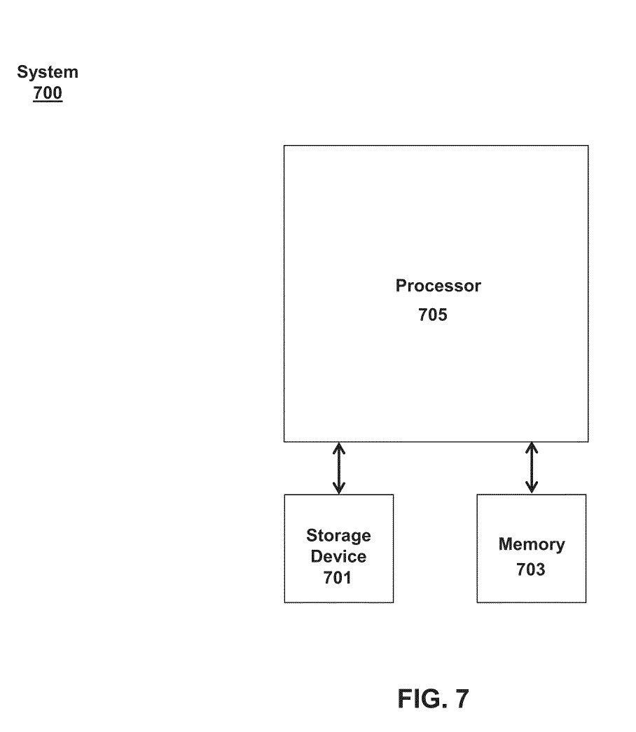

One or more of the functions relating to stylus detection and demodulation described above can be performed by a system similar or identical to system 700 shown in FIG. 7. System 700 can include instructions stored in a non-transitory computer readable storage medium, such as memory 703 or storage device 701, and executed by processor 705. The instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The instructions can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

It is to be understood that the system is not limited to the components and configuration of FIG. 7, but can include other or additional components in multiple configurations according to various examples. Additionally, the components of system 700 can be included within a single device, or can be distributed between multiple devices.

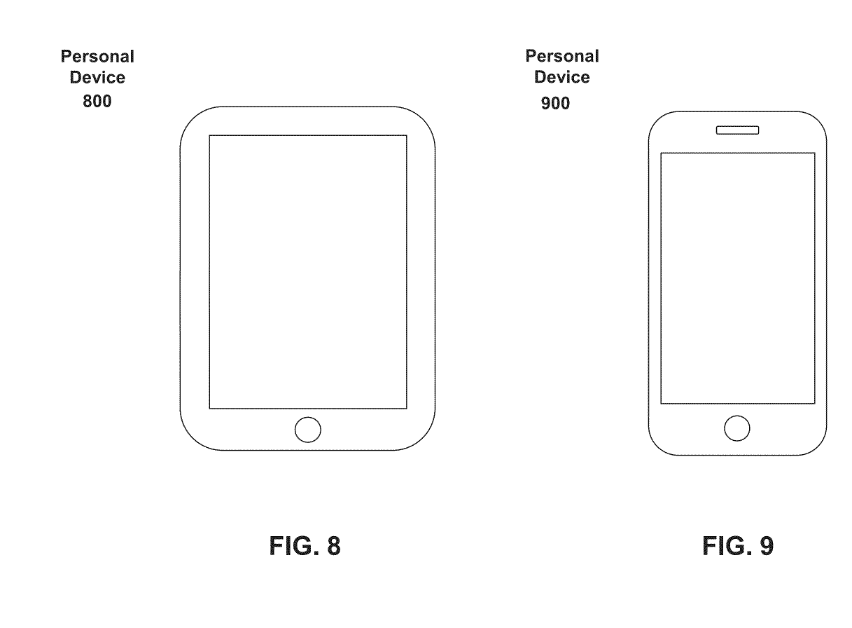

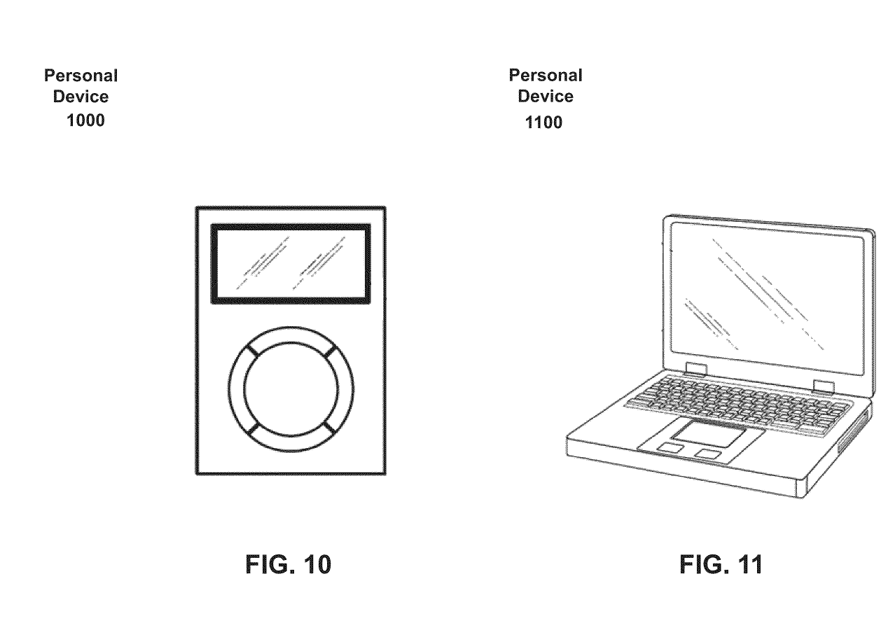

FIGS. 8-11 show example systems in which a superheterodyne stylus signal receivers according to examples of the disclosure may be implemented. FIG. 8 illustrates an exemplary personal device 800, such as a tablet, that can be used with a superheterodyne stylus signal receiver according to various examples. FIG. 9 illustrates another exemplary personal device 900, such as a mobile phone, that can be used with a superheterodyne stylus signal receiver according to various examples. FIG. 10 illustrates yet another exemplary personal device 1000, such as a portable media player, that can be used with a superheterodyne stylus signal receiver according to various examples. FIG. 11 illustrates another exemplary personal device 1100, such as a laptop computer, that can be used with a superheterodyne stylus signal receivers according to various examples.

Therefore, according to the above, some examples of the disclosure are directed to a signal receiver comprising: down-converting circuitry coupled to receive a touch signal representative of a touch event on a touch sensor, wherein the touch signal is generated in response to a stylus stimulation signal from a stylus device, and wherein the down-converting circuitry is operable to convert the touch signal into an intermediate frequency signal having an intermediate frequency that is less than a frequency of the touch signal; and a processor operable to demodulate the intermediate frequency signal to determine an amplitude of the touch signal. Additionally or alternatively to one or more of the examples disclosed above, in some examples, the down-converting circuitry can include an analog to digital converter operable to convert the touch signal into a digital touch signal. Additionally or alternatively to one or more of the examples disclosed above, in some examples, the down-converting circuitry can further include a mixer operable to mix the digital touch signal with a demodulation signal to output the intermediate frequency signal. Additionally or alternatively to one or more of the examples disclosed above, in some examples, the down-converting circuitry can further include an integrator operable to integrate the intermediate frequency signal. Additionally or alternatively to one or more of the examples disclosed above, in some examples, demodulating the intermediate frequency signal to determine the amplitude of the touch signal can include performing an I-phase demodulation on the intermediate frequency signal and performing a Q-phase demodulation on the intermediate frequency signal.

Some examples of the disclosure are directed to a touch sensitive device comprising: a touch sensor; down-converting circuitry coupled to receive a touch signal representative of a touch event on the touch sensor, wherein the touch signal is generated in response to a stylus stimulation signal from a stylus device, and wherein the down-converting circuitry is operable to convert the touch signal into an intermediate frequency signal having an intermediate frequency that is less than a frequency of the touch signal; and a processor operable to demodulate the intermediate frequency signal to determine an amplitude of the touch signal. Additionally or alternatively to one or more of the examples disclosed above, in some examples, the frequency of the touch signal can be 110 KHz and the intermediate frequency can be 500 Hz. Additionally or alternatively to one or more of the examples disclosed above, in some examples, the processor can be further operable to determine a location of the stylus on the touch sensor based on the amplitude of the touch signal.

Some examples of the disclosure are directed to a touch sensitive device comprising: a touch sensor comprising a plurality of drive lines and a plurality of sense lines; drive circuitry coupled to the plurality of drive lines and operable to generate a plurality of stimulation signals having a first frequency; sense circuitry coupled to the plurality of sense lines, the sense circuitry comprising: a plurality of touch receivers operable to demodulate touch signals having the first frequency; and a plurality of stylus receivers operable to demodulate touch signals having a second frequency corresponding to a frequency of a stimulation signal of a stylus, wherein the first frequency is different than the second frequency. Additionally or alternatively to one or more of the examples disclosed above, in some examples, the plurality of stylus receivers can be operable to down-convert the touch signals having the second frequency to intermediate frequency signals having an intermediate frequency that is less than the second frequency. Additionally or alternatively to one or more of the examples disclosed above, in some examples, the plurality of stylus receivers can be further operable to demodulate the intermediate frequency signals at the intermediate frequency. Additionally or alternatively to one or more of the examples disclosed above, in some examples, the plurality of stylus receivers can be operable to down-convert the touch signals using a demodulation mixer and the plurality of stylus receivers can be operable to demodulate the intermediate frequency signals using a processor. Additionally or alternatively to one or more of the examples disclosed above, in some examples, the touch sensitive device can include a phone, a tablet computer, a portable media player, or a laptop computer.

Some examples of the disclosure are directed to a method comprising: receiving a touch signal representative of a touch event on a touch sensor, wherein the touch signal is generated in response to a stylus stimulation signal from a stylus device; converting the touch signal into an intermediate frequency signal having an intermediate frequency that is less than a frequency of the touch signal; and demodulating the intermediate frequency signal to determine an amplitude of the touch signal. Additionally or alternatively to one or more of the examples disclosed above, in some examples, converting the touch signal into an intermediate frequency signal can include mixing the touch signal with a demodulation signal having a frequency that is different than the frequency of the touch signal. Additionally or alternatively to one or more of the examples disclosed above, in some examples, a difference between the frequency of the demodulation signal and the frequency of the touch signal can correspond to the intermediate frequency. Additionally or alternatively to one or more of the examples disclosed above, in some examples, the method can further include integrating the intermediate frequency signal over a duration that is less than half of a period of the intermediate frequency signal. Additionally or alternatively to one or more of the examples disclosed above, in some examples, demodulating the intermediate frequency signal to determine the amplitude of the touch signal can include performing an I-phase demodulation on the intermediate frequency signal and performing a Q-phase demodulation on the intermediate frequency signal. Additionally or alternatively to one or more of the examples disclosed above, in some examples, performing the I-phase demodulation on the intermediate frequency signal can include: mixing the intermediate frequency signal with an I-phase demodulation signal having a frequency substantially equal to the intermediate frequency; and integrating a result of the mixing of the intermediate frequency signal and the I-phase demodulation signal. Additionally or alternatively to one or more of the examples disclosed above, in some examples, performing the Q-phase demodulation on the intermediate frequency signal can include: mixing the intermediate frequency signal with an Q-phase demodulation signal having a frequency substantially equal to the intermediate frequency, wherein the Q-phase demodulation signal is 90-degrees out of phase with the I-phase demodulation signal; and integrating a result of the mixing of the intermediate frequency signal and the Q-phase demodulation signal.

Although examples have been fully described with reference to the accompanying drawings, it is to be noted that various changes and modifications will become apparent to those skilled in the art. Such changes and modifications are to be understood as being included within the scope of the various examples as defined by the appended claims.

What is claimed is:

1: A signal receiver comprising:
down-converting circuitry coupled to receive a touch signal representative of a touch event on a touch sensor, wherein the touch signal is generated in response to a stylus stimulation signal from a stylus device, and wherein the down-converting circuitry is operable to convert the touch signal into an intermediate frequency signal having an intermediate frequency that is less than a frequency of the touch signal; and
a processor operable to demodulate the intermediate frequency signal to determine an amplitude of the touch signal.

2: The signal receiver of claim 1, wherein the down-converting circuitry comprises an analog to digital converter operable to convert the touch signal into a digital touch signal.

3: The signal receiver of claim 2, wherein the down-converting circuitry further comprises a mixer operable to mix the digital touch signal with a demodulation signal to output the intermediate frequency signal.

4: The signal receiver of claim 3, wherein the down-converting circuitry further comprises an integrator operable to integrate the intermediate frequency signal.

5: The signal receiver of claim 1, wherein demodulating the intermediate frequency signal to determine the amplitude of the touch signal comprises performing an I-phase demodulation on the intermediate frequency signal and performing a Q-phase demodulation on the intermediate frequency signal.

6: A touch sensitive device comprising:
a touch sensor;
down-converting circuitry coupled to receive a touch signal representative of a touch event on the touch sensor, wherein the touch signal is generated in response to a stylus stimulation signal from a stylus device, and wherein the down-converting circuitry is operable to convert the touch signal into an intermediate frequency signal having an intermediate frequency that is less than a frequency of the touch signal; and
a processor operable to demodulate the intermediate frequency signal to determine an amplitude of the touch signal.

7: The touch sensitive device of claim 6, wherein the frequency of the touch signal is 110 KHz, and wherein the intermediate frequency is 500 Hz.

8: The touch sensitive device of claim 6, wherein the processor is further operable to determine a location of the stylus on the touch sensor based on the amplitude of the touch signal.

9: A touch sensitive device comprising:
a touch sensor comprising a plurality of drive lines and a plurality of sense lines;
drive circuitry coupled to the plurality of drive lines and operable to generate a plurality of stimulation signals having a first frequency;
sense circuitry coupled to the plurality of sense lines, the sense circuitry comprising:
a plurality of touch receivers operable to demodulate touch signals having the first frequency; and
a plurality of stylus receivers operable to demodulate touch signals having a second frequency corresponding to a frequency of a stimulation signal of a stylus, wherein the first frequency is different than the second frequency.

10: The touch sensitive device of claim 9, wherein the plurality of stylus receivers are operable to down-convert the touch signals having the second frequency to intermediate frequency signals having an intermediate frequency that is less than the second frequency.

11: The touch sensitive device of claim 10, wherein the plurality of stylus receivers are further operable to demodulate the intermediate frequency signals at the intermediate frequency.

12: The touch sensitive device of claim 11, wherein the plurality of stylus receivers are operable to down-convert the touch signals using a demodulation mixer, and wherein the plurality of stylus receivers are operable to demodulate the intermediate frequency signals using a processor.

13: The touch sensitive device of claim 9, wherein the touch sensitive device comprises a phone, a tablet computer, a portable media player, or a laptop computer.

14: A method comprising:
receiving a touch signal representative of a touch event on a touch sensor, wherein the touch signal is generated in response to a stylus stimulation signal from a stylus device;
converting the touch signal into an intermediate frequency signal having an intermediate frequency that is less than a frequency of the touch signal; and
demodulating the intermediate frequency signal to determine an amplitude of the touch signal.

15: The method of claim 14, wherein converting the touch signal into an intermediate frequency signal comprises mixing the touch signal with a demodulation signal having a frequency that is different than the frequency of the touch signal.

16: The method of claim 15, wherein a difference between the frequency of the demodulation signal and the frequency of the touch signal corresponds to the intermediate frequency.

17: The method of claim 14, further comprising integrating the intermediate frequency signal over a duration that is less than half of a period of the intermediate frequency signal.

18: The method of claim 14, wherein demodulating the intermediate frequency signal to determine the amplitude of the touch signal comprises performing an I-phase demodulation on the intermediate frequency signal and performing a Q-phase demodulation on the intermediate frequency signal.

19: The method of claim 18, wherein performing the I-phase demodulation on the intermediate frequency signal comprises:
mixing the intermediate frequency signal with an I-phase demodulation signal having a frequency substantially equal to the intermediate frequency; and
integrating a result of the mixing of the intermediate frequency signal and the I-phase demodulation signal.

20: The method of claim 19, wherein performing the Q-phase demodulation on the intermediate frequency signal comprises:
mixing the intermediate frequency signal with an Q-phase demodulation signal having a frequency substantially equal to the intermediate frequency, wherein the Q-phase demodulation signal is 90-degrees out of phase with the I-phase demodulation signal; and
integrating a result of the mixing of the intermediate frequency signal and the Q-phase demodulation signal.
